(19) United States
(12) Patent Application Publication
(10) Pub. No.: US 2006/0107810 A1
(43) Pub. Date: May 25, 2006

(54) Mitre saw

(75) Inventor: Cheng-Hung Chiu, Taichung (TW)

Correspondence Address: BACON & THOMAS, PLLC, 625 SLATERS LANE, FOURTH FLOOR, ALEXANDRIA, VA, 22314, US

(73) Assignee: Rexon Industrial Corp., Ltd., Taichung (TW)

(21) Appl. No.: 11/052,985

(22) Filed: Feb. 9, 2005

(30) Foreign Application Priority Data
Nov. 25, 2004 (TW) 93218984

(51) Int. Cl. B26D 7/06; B26D 5/08

(52) U.S. Cl. 83/100; 83/581

(57) ABSTRACT

A mitre saw includes a base, a pivot arm assembly pivoted to the base, a saw blade rotatably connected to a motor that is mounted to the pivot arm assembly, an outer dust duct fixedly fastened to the pivot arm assembly and connected to a dust passage, an inner dust duct, which is movably inserted into the outer dust duct and has an inlet kept in proximity to a bottom side of the saw blade and an outlet disposed inside the outer dust duct, and a linkage coupled between the base and the inner dust duct for moving the inner dust duct in and out of the outer dust duct subject to the pivoting motion of the pivot arm assembly relative to the base to keep the inlet of the inner dust duct constantly in proximity to the bottom side of the saw blade.

### BACKGROUND OF THE INVENTION

1. Field of the Invention

The present invention relates generally to a sawing apparatus and more particularly, to a mitre saw that provides a dust collection function.

2. Description of the Related Art

U.S. Pat. No. 5,819,619 discloses a dust collection system for compound miter saw. According to this design, as shown in FIG. 1 of the patent specification, the saw 10 (the following reference numerals refer to the reference numerals used in the patent) comprises a base assembly 12, a pivot arm assembly 21, a saw blade 14, and a motor 17. As shown in FIG. 4 of the patent specification, the pivot arm assembly 21 comprises a dust duct 33 disposed adjacent to the base assembly 12. The dust duct 33 has a dust-receiving opening 35 aimed at the bottom side of the saw blade 14, and an outlet opening 39 connected to a dust collection bag accessory 63. When starting the motor 17 to rotate the saw blade 14 after the pivot arm assembly 21 has been biased to the workpiece 11 on the base assembly 12, dust during operation of the saw 10 is forced into the dust-receiving opening 35 of the dust duct 33 and then the dust collection bag accessory 63 via the outlet opening 39 by the rotating flow of air produced following the centrifugal force from the rotating saw blade 14. Therefore, the dust duct 33 collects dust during performance of the saw 10.

According to the aforesaid design, the dust duct 33 is fixedly fastened to the pivot arm assembly 21, and the distance between the dust-receiving opening 35 of the dust duct 33 and the cutting point of the saw blade 14 at the workpiece 11 varies with the biasing angle of the pivot arm assembly 21. When the dust-receiving opening 35 of the dust duct 33 is maintained in proximity to the workpiece 11, the dust duct 33 collects dust efficiently. However, when the dust-receiving opening 35 of the dust duct 33 is kept at a relatively farther position from the workpiece 11, dust cannot be fully guided into the dust duct 33 and a part of dust will fly away to contaminate the surroundings. Other designs, for example, U.S. Pat. Nos. 6,470,778 and 6,510,772 have the dust-receiving opening of the dust duct fixedly fastened to the base assembly or pivot arm, thereby encountering the same problem.

### SUMMARY OF THE INVENTION

The present invention has been accomplished under the circumstances in view. It is the main object of the present invention to provide a mitre saw, which effectively collects dust during performance.

To achieve this object of the present invention, the mitre saw provided by the present invention comprises a base, a pivot arm assembly pivotally connected to the base and turnable relative to the base, a saw blade rotatably connected to a motor that is mounted to an end of the pivot arm assembly remote from the base, an outer dust duct fixedly fastened to the pivot arm assembly and connected to a dust passage, an inner dust duct which is axially movably inserted into the outer dust duct and has an inlet kept in proximity to the saw blade and an outlet disposed inside the outer dust duct, and transmission means for moving the inner dust duct in and out of the outer dust duct subject to a pivoting motion of the pivot arm assembly relative to the base.

In a preferred embodiment of the present invention, the transmission means is a linkage coupled between the base and the inner dust duct.

Preferably, the pivot arm assembly is provided with a through hole and a connecting tube is mounted in the through hole and forms with the through hole the dust passage.

Preferably, the inner dust duct has a longitudinal slot formed in a top side thereof and extending from the inlet toward the outlet for receiving a bottom side of the saw blade.

### BRIEF DESCRIPTION OF THE DRAWINGS

FIG. 1 is an exploded view of a mitre saw according to a preferred embodiment of the present invention.

FIG. 2 is a sectional view of a part of the mitre saw according to the preferred embodiment of the present invention.

FIG. 3 is a side plain view of the mitre saw according to the preferred embodiment of the present invention.

FIG. 4 is similar to FIG. 3 but showing the pivot arm biased toward the base.

FIG. 5 is another side view of the present invention, showing the saw blade cut into the workpiece.

### DETAILED DESCRIPTION OF THE INVENTION

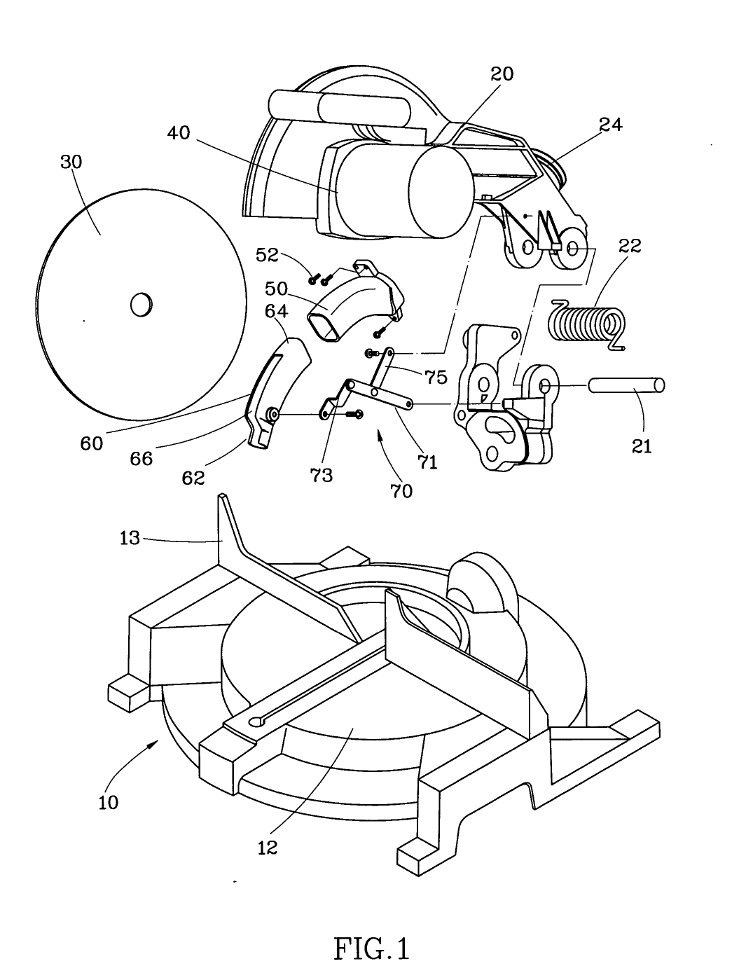

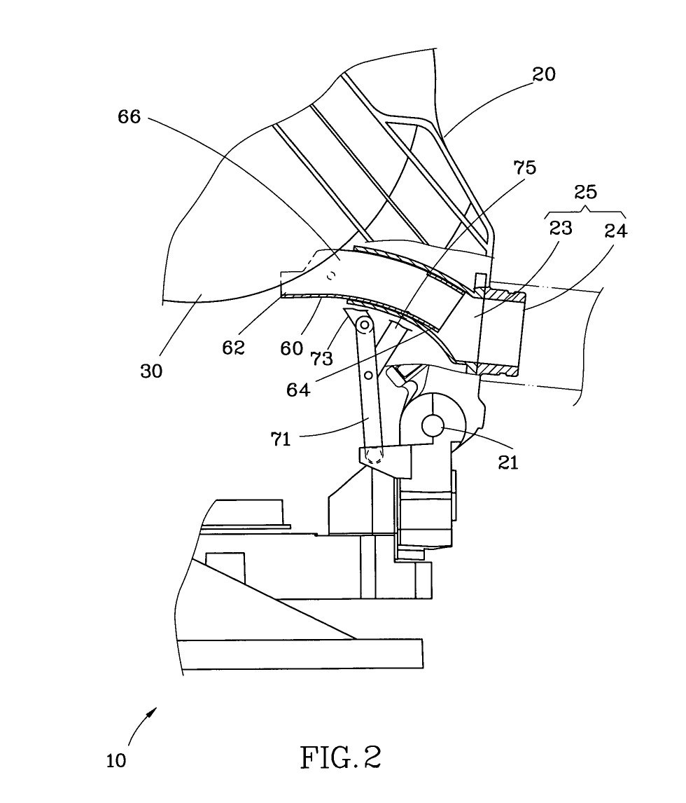

Referring to FIGS. 1-3, a mitre saw in accordance with the preferred embodiment of the present invention is shown comprised of a base 10, a pivot arm assembly 20, a saw blade 30, a motor drive 40, an outer duct 50, an inner duct 60, and transmission means 70.

The base 10 comprises a cutting surface 12 and a fence 13 at the cutting surface 12 for supporting the workpiece 14 in the cutting position for cutting.

The pivot arm assembly 20 is pivoted to the base 10 with the bottom end thereof by a pivot pin 21, and upwardly downwardly turnable about the pivot pin 21 relative to the base 10. A torsional spring 22 is provided between the base 10 and the pivot arm assembly 20, imparting an upward biasing force to the pivot arm assembly 20. The pivot arm assembly 20 has a through hole 23 and a connecting tube 24 mounted in the through hole 23. The through hole 23 is defined in the pivot arm assembly 20 above the elevation of the pivot pin 21. The connecting tube 24 protrudes over the rear side of the pivot arm assembly 20. The through hole 23 and the connecting tube 24 form a dust collection passage 25. The connecting tube 24 is connectable to dust exhaust means (not shown).

The saw blade 30 is rotatably connected to the motor drive 40 that is mounted in the top end of the pivot arm assembly 20, located at the top end of the pivot arm assembly 20, and movable with the pivot arm assembly 20 relative to the base 10.

The motor drive 40 is mounted in the top end of the pivot arm assembly 20 for rotating the saw blade 30.

The outer dust duct 50 is fastened to the pivot arm assembly 20 with screws 52, having one end connected to the dust passage 25 and the other end aimed at the saw blade 30.

The inner dust duct 60 has an inlet 62 and an outlet 64. Further, the inner dust duct 60 is a tapered tube having a circular inner diameter gradually reducing in direction from the outlet 64 toward the inlet 62. Further, the inner dust duct 60 has a longitudinal slot 66 defined in the top side and extending from the inlet 62 to a distance toward the outlet 64. The outlet 64 of the inner dust duct 60 is inserted into the outer dust duct 50. The inlet 62 of the inner dust duct 60 is kept in proximity to the periphery (cutting teeth) of the saw blade 30, for allowing a part of the bottom side of the saw blade 30 to be suspended in the longitudinal slot 66 inside the inner dust duct 60.

The transmission means 70 according to the present preferred embodiment is a linkage comprised of s a first link 71, a second link 73, and a third link 75. The first link 71 has one end pivoted to the base 10 adjacent to the pivot arm assembly 20, and the other end pivoted to one end of the second link 73. The other end of the second link 73 is pivoted to one side of the inner dust duct 60. The third link 75 has one end pivoted to a part of the first link 71, and the other end pivoted to the pivot arm assembly 20 adjacent to the outer dust duct 50. When biasing the pivot arm assembly 20, the third link 75 is forced by the first link 71 and the second link 73 to move the inner dust duct 60 axially relative to the outer dust duct 50.

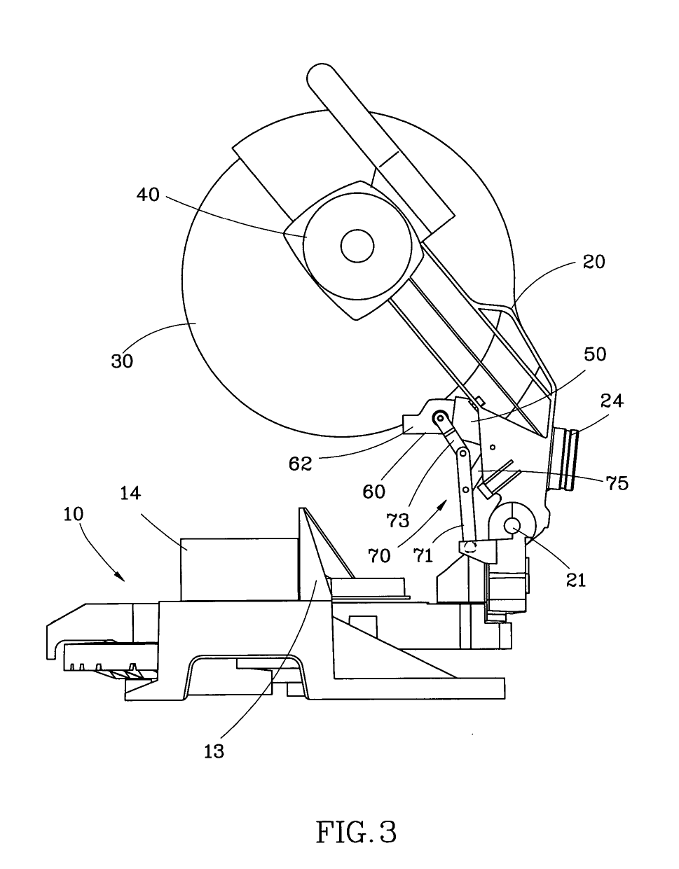

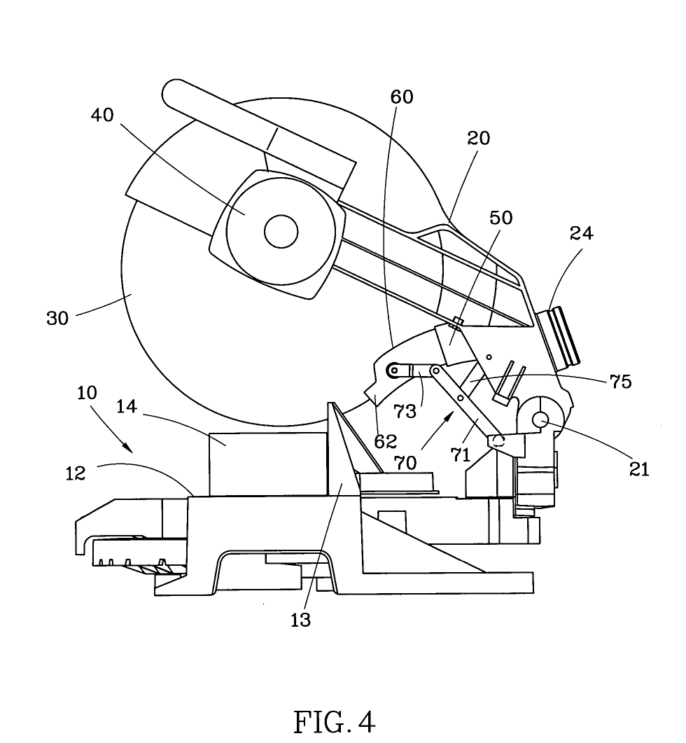

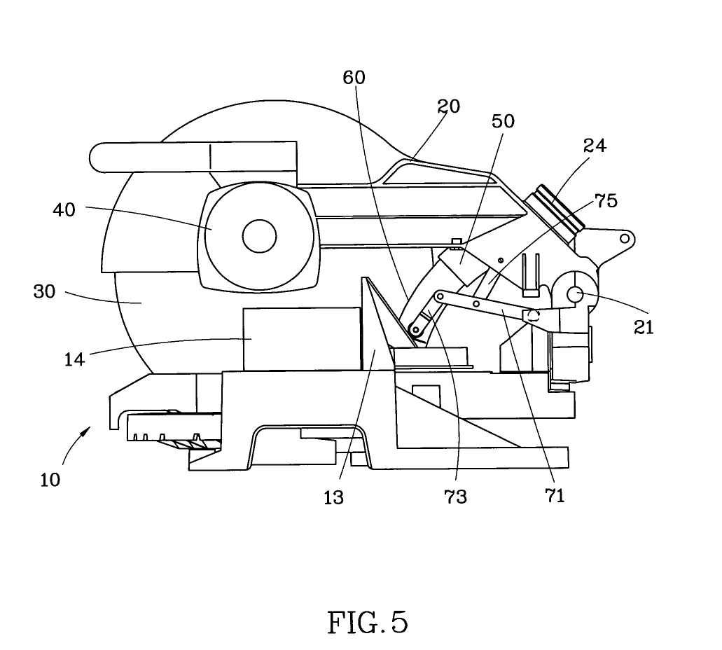

Referring to FIGS. 4 and 5 and FIG. 3 again, when operating the pivot arm assembly 20 to lower the saw blade 30 to cut the workpiece 14, the third link 75 is lowered with the pivot arm assembly 20 to push the first link 71, thereby causing the second link 73 to be forced by the first link 71 to move the inner dust duct 60 out of the outer dust duct 50, thereby keeping the inlet 62 of the inner dust duct 60 in proximity to the bottom side of the saw blade 30 to collect dust from the workpiece 14. At this time, dust is forced by the centrifugal force from rotation of the saw blade 30 into the inlet 62 of the inner dust duct 60 and then into the outer dust duct 50 and the dust passage 25. Further, because the inlet 62 has a circular cross section, the inner dust duct 60 can suck in dust from the workpiece 14 efficiently without causing easily a turbulent flow of air. When continuously lowering the pivot arm assembly 20 toward the workpiece 14 during cutting operation of the saw blade 30, the inner dust duct 60 is relatively moved out of the outer dust duct 50, enabling dust to be smoothly guided out of the dust passage 25.

By means of the retractable inner dust duct and outer dust duct arrangement and the transmission means, the invention achieves a high performance of dust collection operation.

Although a particular embodiment of the invention has been described in detail for purposes of illustration, various modifications and enhancements may be made without departing from the spirit and scope of the invention. For example, two linkages may be used and symmetrically provided at two sides for moving the inner dust duct relative to the outer dust duct following the pivoting action of the pivot arm assembly. Accordingly, the invention is not to be limited except as by the appended claims.

What is claimed is:

1. A mitre saw comprising:
a base;
a pivot arm assembly pivotally connected to said base and turnable relative to said base;
a saw blade rotatably disposed at an end of said pivot arm assembly remote from said base;
driving means for rotating said saw blade;
an outer dust duct fixedly fastened to said pivot arm assembly and connected to a dust passage;
an inner dust duct movably inserted into said outer dust duct, said inner dust duct having an inlet kept in proximity to said saw blade and an outlet disposed inside said outer dust duct; and
transmission means coupled between said base and said inner dust duct for moving said inner dust duct in and out of said outer dust duct subject to a pivoting motion of said pivot arm assembly relative to said base.

2. The mitre saw as claimed in claim 1, wherein said transmission means is a linkage.

3. The mitre saw as claimed in claim 2, wherein said linkage comprises a first link, which has a first end pivoted to said base adjacent to said pivot arm assembly and a second end, a second link, which has a first end pivoted to the second end of said first link and a second end pivoted to said inner dust duct, and a third link, which has a first end pivoted to said first link and a second end pivoted to said pivot arm assembly adjacent to said outer dust duct for enabling said third link to drive said first link and said second link to move said inner dust duct relative to said outer dust duct upon a pivoting motion of said pivot arm assembly relative to said base.

4. The mitre saw as claimed in claim 1, wherein said inner dust duct is a tapered tube having an inner diameter gradually reducing in direction from said outlet toward said inlet.

5. The mitre saw as claimed in claim 1, wherein said inlet of said inner dust duct has a circular cross section.

6. The mitre saw as claimed in claim 1, wherein said pivot arm assembly comprises a through hole disposed adjacent to a pivoted point between said pivot arm assembly and said base, and a connecting tube mounted in said through hole and forming with said through hole said dust passage.

7. The mitre saw as claimed in claim 1, wherein said inner dust duct has a longitudinal slot formed in a top side thereof and extending from said inlet toward said outlet for receiving a bottom side of said saw blade.
